(19) United States
(12) Patent Application Publication
(10) Pub. No.: US 2007/0115484 A1
(43) Pub. Date: May 24, 2007

(54) 3D SHAPE MEASUREMENT SYSTEM AND METHOD INCLUDING FAST THREE-STEP PHASE SHIFTING, ERROR COMPENSATION AND CALIBRATION

(76) Inventors: Peisen Huang, Stony Brook, NY (US); Song Zhang, Somerville, MA (US)

Correspondence Address: Peter I. Bernstein;Scully, Scott, Murphy & Presser, Suite 300, 400 Garden City Plaza, Garden City, NY, 11530, US

(21) Appl. No.: 11/552,520

(22) Filed: Oct. 24, 2006

Related U.S. Application Data
(60) Provisional application No. 60/729,771, filed on Oct. 24, 2005.

(51) Int. Cl. G01B 11/30

(52) U.S. Cl. 356/604

(57) ABSTRACT

A structured light system for object ranging/measurement is disclosed that implements a trapezoidal-based phase-shifting function with intensity ratio modeling using sinusoidal intensity-varied fringe patterns to accommodate for defocus error. The structured light system includes a light projector constructed to project at least three sinusoidal intensity-varied fringe patterns onto an object that are each phase shifted with respect to the others, a camera for capturing the at least three intensity-varied phase-shifted fringe patterns as they are reflected from the object and a system processor in electrical communication with the light projector and camera for generating the at least three fringe patterns, shifting the patterns in phase and providing the patterns to the projector, wherein the projector projects the at least three phase-shifted fringe patterns sequentially, wherein the camera captures the patterns as reflected from the object and wherein the system processor processes the captured patterns to generate object coordinates.

### CROSS REFERENCE TO RELATED APPLICATIONS

The present application claims benefit of U.S. Provisional Application No. 60/729,771, filed Oct. 24, 2005.

### BACKGROUND OF THE INVENTION

The present invention relates to 3D shape measurement. More particularly, the invention relates to a structured light system for 3D shape measurement, and method for 3D shape measurement that implements improved three-step phase-shifting and processing functions, phase error compensation and system calibration.

Three dimensional (3D) surface, and object shape measurement is a rapidly expanding field with applications in numerous diverse fields such as computer graphics, virtual reality, medical diagnostic imaging, robotic vision, aeronautics, manufacturing operations such as inspection and reverse engineering, security applications, etc. Recent advances in digital imaging, digital projection display and personal computers provide a basis for carrying out 3D shape measurement using structured light systems in speeds approaching real-time. The known conventional approaches to ranging and 3D shape measurement include the aforementioned structured light systems and associated techniques, and stereovision systems and associated techniques.

Stereovision 3D shape measurement techniques estimate shape by establishing spatial correspondence of pixels comprising a pair of stereo images projected onto an object being measured, capturing the projected images and subsequent processing. But traditional stereovision techniques are slow and not suited for 3D shape measurement in real time. A recently developed stereovision technique, referred to as spacetime stereo, extends matching of stereo images into the time domain. By using both spatial and temporal appearance variations, the spacetime stereovision technique shows reduced matching ambiguity and improved accuracy in 3D shape measurement. The spacetime stereovision technique, however, is operation-intensive, and time consuming. This limits its use in 3D shape measurement, particularly where it is desired to use the spacetime stereo techniques for speeds approaching real-time applications.

Structured light techniques, sometimes referred to as ranging systems, utilize various coding methods that employ multiple coding patterns to measure 3D objects quickly without traditional scanning. Known structured light techniques tend to use algorithms that are much simpler than those used by stereovision techniques, and thus better suited for real-time applications. Two basic structured light approaches are known for 3D shape measurement. The first approach uses a single pattern, typically a color light pattern generated digitally and projected using a projector. Since the first structured light approach uses color to code the patterns, the shape acquisition result is affected to varying degrees by variations in an object's surface color. In general, the more patterns used in a structured light system for shape measurement, the better the accuracy that can be achieved.

The second structured light approach for real-time 3D shape acquisition and measurement uses multiple binary-coded patterns, the projection of which is rapidly switched so that the pattern is captured in a cycle implemented in a relatively short period. Until recently, spatial resolution using such multiple-coded pattern techniques has been limited because stripe width is required to be larger than a single pixel. Moreover, such structured light techniques require that the patterns be switched by repeated loading to the projector, which limits switching speeds and therefore the speed of shape acquisition and processing. A method and apparatus for 3D surface contouring using a digital video projection system, i.e., a structured light system, is described in detail in U.S. Pat. No. 6,438,272 (the '272 patent), commonly owned and incorporated by reference in its entirety herein.

The invention disclosed in the '272 patent is based on full-field fringe projection with a digital video projector, and captures the projected full-field fringe patterns with a camera to carry out three-step phase shifting. Another known structured light method and apparatus for 3D surface contouring and ranging also uses digital video projection and camera, and is descried in detail in U.S. Pat. No. 6,788,210 (the '210 patent), incorporated by reference in its entirety herein. The invention disclosed in the '210 patent is based on digital fringe projection and capture utilizes three-step phase shifting using an absolute phase mark pattern. While the patented methods and apparatuses have significantly contributed to the advancing art of digital structured light systems and techniques, they nevertheless fall short with respect to speed. That is, neither is found to be able to measure and range at speeds necessary for real-time operation.

A relatively high speed 3D shape measurement technique based on rapid phase shifting was recently developed by Huang, et al., and disclosed in their paper: High-speed 3D Shape Measurement Based on Digital Fringe Projection, Opt. Eng., vol. 42, no. 1, pp. 163-168, 2003 (“the Huang paper”). The technique and system disclosed in the Huang paper is structured-light based, utilizing three phase-shifted, sinusoidal grayscale fringe patterns to provide desirable pixel-level resolution. The Huang paper asserts that fringe patterns may be projected onto object for measurement at switching speeds of up to 240 Hz., but that acquisition is limited by the frame rate of the camera used to 16 Hz.

Song Zhang and Peisen Huang, in their publication entitled: High-resolution, Real-time 3D Shape Acquisition, Proceedings of the 2004 IEEE Computer Society Conference on Computer Vision and Pattern Recognition Workshops (CVPRW'04), disclosed an improved version of the technique found in the Huang paper, and a system for implementing the technique. Hereinafter, the system and method disclosed in the 2004 Zhang/Huang publication will be referred to as either “the 2004 structured light system” or “the 2004 structured light method” for simplicity. The 2004 structured light system may not be said to carry out 3D shape measurement in real time. The 2004 structured light system includes the use of single-chip DLP technology for rapid projection switching of three binary color-coded fringe patterns. The color-coded fringe patterns are projected rapidly using a slightly modified version of the projector's red, green and blue channels.

The patterns are generated by a personal computer (PC) included in the system. The patterns are projected onto the object surface by the DLP projector in sequence, repeatedly and rapidly. The DLP projector is modified so that its color wheel is disengaged, so the actual projected fringe patterns are projected, and captured in gray-scale. The capturing is accomplished using a synchronized, high-speed back and white (B/W) CCD-based camera, from which 3D information of the object surfaces is retrieved. A color CCD camera, which is synchronized with the projector and aligned with the B/W camera, is included to acquire 2D color images of the object at a frame rate of 26.8 Hz for texture mapping. Upon capture, the 2004 structured light system and method processes the three patterns using both sinusoidal-based three-step phase shifting, where the patterns are projected sinusoidally, and with a trapezoidal-based three-step phase shifting, where the patterns are projected trapezoidally. Both phase-shifting techniques require that the respective projected patterns are shifted in phase or 120 degrees, or 2π/3. The trapezoidal-based technique developed in view of the fact that the sinusoidal-based technique utilizes an arctangent function to calculate the phase, which is slow.

FIG. 1 depicts one embodiment of the 2004 structured light system 100 (system 100), for near real-time 3-D shape measurement. System 100 is constructed to implement either sinusoidal-based three-step phase shifting with sinusoidal intensity modulated projecting, or the trapezoidal-based three-step phase-shifting with trapezoidal intensity modulated projecting. System 100 includes a digital light-processing (“DLP”) projector 110, a CCD-based digital color camera 120, a CCD-based digital B/W camera 130, and two personal computers, PC1 and PC2, connected a RS232 link as shown, and a beamsplitter 140. PC1 communicates directly with DLP projector 110, and PC2 communicates directly with color camera 120 and B/W camera 130. The beamsplitter 140 is disposed in line of sight of the cameras. A CPU or processor in PC1 generates the three binary-coded color fringe patterns, R (152), G (154), B (156), and generates a combined RGB fringe pattern 150 therefrom. The combined RGB fringe pattern is sent to the DLP projector 110, modified from its original form by removing the color filters on its color wheel.

Accordingly, the projector operates in monochrome to project the color pattern 150 in gray scale, that is, by its r, g and b channels as three gray scale patterns, 152′, 154′ and 156′ onto the 3D object for measurement. The channels that provide for the projection of the three gray scale patterns (152′, 154′ and 156′) switch rapidly at 240 Hz/channel. High-speed B/W camera 130 is synchronized to the DLP projector 110 for capturing the three patterns (152′, 154′, 156′). Color camera 120, is used to capture the projected patterns for texture mapping (at about 27 Hz.). To realize more realistic rendering of the object surface, a color texture mapping method was used.

When system 100 implements the sinusoidal-based phase-shifting with sinusoidal-based intensity modulation with sinusoidal intensity modulation, the images captured by color camera 120 and B/W camera 130 are transferred to PC2, wherein phase information at every pixel is extracted using the arctangent function. Processing in PC2 also averages the three grayscale patterns as projected, washing out the fringes (discussed in greater detail below). But where the sinusoidal patterns are not truly sinusoidal due to non-linear effects from the DLP projector 110, residual fringes are found to exist. And because aligning the two cameras is difficult, a coordinate transformation is performed to match the pixels between the two cameras. A projective transformation used is:
I_{bw}(x,y)=PI_{c}(x,y),
where I_{bw} is the intensity of the B/W image, I_{c} is the intensity of the color image, and P is a 3×3 planar perspective coordinate transformation matrix. The coordinate parameters of matrix P depend on system setup, which only need to be determined once through calibration. Once the coordinate relationship between the two cameras is determined, each corresponding pixel in any image pixel in the color fringe pattern image may be determined for texture mapping.

Perhaps more importantly than texture mapping, the pixel phase information supports determining the correspondence between the image field and the projection field using triangulation. Using the sinusoidal-based phase-shifting technique require three steps. Using a 120 degree phase shift, the three steps are defined mathematically as follows:
Iᵣ(x,y)=I′(x,y)+I″(x,y)cos[φ(x,y)−2π/3],
I_{g}(x,y)=I′(x,y)+I″(x,y)cos[φ(x,y)],
I_{b}(x,y)=I′(x,y)+I″(x,y)cos[φ(x,y)+2π/3].
In the equations, I′(x,y) is the average intensity, I″(x,y) is the intensity modulation, and φ(x,y) is the phase to be determined.

Solving the three equations simultaneously for φ(x,y) realizes:
φ(x,y)=arctan[(3)^{1/2}(Ir−Ib)/(2Ig−Ir−Ib)]
As mentioned briefly above, the arctangent-based equation provides for modulo 2π phase at each pixel whose values range from 0 to 2π. Removing the 2π discontinuities in the projected and captured images require use of a conventional phase unwrapping algorithm. The result of the phase unwrapping is a continuous 3D phase map. The phase map is converted to a depth map by a conventional phase-to-height conversion function. The function presumes that surface height is proportional to the difference between the phase maps of the object and a flat reference plane with a scale factor determined through calibration.

To implement such a three-step phase shifting method in real-time, or near real-time requires high-speed processing of the captured images. And while the sinusoidal-based three step phase shifting is known to realize accurate measurement, it nevertheless performs reconstruction relatively slowly. A significant reason for this is its dependence upon processing the operation-intensive arctangent function. To overcome the limitation in speed, system 100 was constructed to implement a relatively novel trapezoidal three-step phase-shifting function combined with intensity ratio processing for improved overall processing speed, i.e., to near real-time. The trapezoidal-based 2004 structured light method calculates intensity ratio instead of phase. The result is an increased processing speed during reconstructions, again, to near real-time. The following are the intensity equations for the three color channels.

$$\begin{matrix}{I}_{r} ( x , y ) = {I}^{′′} ( 2 - 6 x / T ) + {I}_{0} , & where x ∈ [ T / 6 , T / 3 ] \\ I 0 , & where x ∈ [ T / 3 , 2 T / 3 ] \\ {I}^{′′} ( 6 x / T - 4 ) + {I}_{0} , & where x ∈ [ 2 T / 3 , 5 T / 6 ] \\ {I}_{0} + {I}^{′′} , & otherwise ;\end{matrix}$$

$$\begin{matrix}{I}_{g} ( x , y ) = {I}^{′′} ( 6 x / T ) + {I}_{0} , & where x ∈ [ 0 , T / 6 ] \\ {I}_{0} + {I}^{′′} & where x ∈ [ T / 6 , T / 2 ] \\ {I}^{′′} ( 4 - 6 x / T ) + {I}_{0} , & where x ∈ [ 2 / T , 2 T / 3 ] \\ {I}_{0} , & where x ∈ [ 2 T / 3 , T ]\end{matrix}$$

$$\begin{matrix}{I}_{b} ( x , y ) = {I}_{0} , & where x ∈ [ 0 , T / 3 ] \\ {I}^{′′} ( 6 x / T - 2 ) + {I}_{0} , & where x ∈ [ T / 3 , T / 2 ] \\ {I}_{0} + {I}^{′′} , & where x ∈ [ T / 2 , 5 T / 6 ] \\ {I}^{′′} ( 6 - 6 x / T ) + {I}_{0} , & where x ∈ [ 5 T / 6 , T ] ;\end{matrix}$$

Within the intensity equations, T is the stripe width for each color channel, I₀ is the minimum intensity level, and I″ is the intensity modulation. The stripe is divided into six regions, each of which is identifiable by the intensities of the red, green and blue channels. For each region, the intensity ratio is calculated in a manner that is similar to that utilized in traditional intensity ratio techniques:
r(x,y)=(I_{med}(x,y)−Iₘᵢₙ(x,y))/(Iₘₐₓ(x,y)−Iₘᵢₙ(x,y)),
where r(x,y) is the intensity ratio and Iₘᵢₙ(x,y), I_{med}(x,y) and Iₘₐₓ(x,y) are the minimum, median and maximum intensity value at point (x,y), respectively. r(x,y) has a triangular shape having a value in a range from 0 to 1. Such a triangular shape is converted to a ramp by identifying the region to which the pixel belongs using the following equation:
r(x,y)=2(round((N−1)/2))+(−1)^{N+1}(I_{med}(x,y)−Iₘᵢₙ(x,y))/(Iₘₐₓ(x,y)−Iₘᵢₙ(x,y)),
where N is the region number. The value of r(x,y) ranges from 0 to 6. FIG. 2a shows a cross-section of the fringe pattern used for the trapezoidal phase-shifting method, FIG. 2b shows intensity ratio in a triangular shape and FIG. 2c shows an intensity ratio ramp after removal of the triangular shape.

The 3D shape is reconstructed thereby using triangulation. System 100 may be programmed to repeat the pattern in order to obtain higher spatial resolution, realizing a periodical intensity ratio with a range of [0,6]. Any discontinuity is removed by an algorithm that is similar to the above-mentioned phase unwrapping algorithm used in the conventional sinusoidal three-step phase-shifting technique. A caution and careful attention is warranted, however, when operation includes repeating the pattern. That is, repeating the pattern may create a potential height ambiguity.

The different speed realized by using the two distinct phase-shifting techniques in system 100 is about 4.6 ms for the trapezoidal function, 20.8 ms for the sinusoidal technique. It should be noted that PC2 (which carried out the processing) is a P4 2.8 GHz PC (PC2), and the image size is 532×500 pixels. Compared to the conventional intensity-ratio based methods, the resolution is also improved at least six (6) times using the three-step trapezoidal phase-shifting technique, and the result is found to be less sensitive to the blurring of the projected fringe patterns with objects having a large depth dimension. But while the trapezoidal-based three-step phase-shifting method implemented in system 100 is fast, it has disadvantages. For example, the method requires compensation for image defocus error when used to measure certain shapes. What would be desirable in the art of structured light system for 3D shape measurement and method capable of implementing trapezoidal-based three-step phase-shifting that avoids fringe pattern blurring.

### SUMMARY OF THE INVENTION

To that end, the present invention sets forth a structured light system for 3D shape measurement that implements a novel sinusoidal-based three-step phase shifting algorithm wherein an arctangent function found in traditional sinusoidal-based algorithms is replaced with a novel intensity ratio function, significantly improving system operational speeds. The inventive structured light system also implements a novel phase error compensation function that compensates for non-linearity of gamma curves that are inherent in projector use, as well as a novel calibration function that uses a checkerboard pattern for calibrating the camera, and allows the projector to be calibrated like the camera and facilitates the establishment of the coordinate relationship between the camera and projector. Once the intrinsic and extrinsic parameters of the camera and projector are determined, the calibration algorithm readily calculates the xyz coordinates of the measurement points on the object.

The inventive structured light system and method for improved real-time 3D shape measurement operates much more quickly than the prior art systems and methods, i.e., up to 40 frames/second, which is true real time operation. The novel sinusoidal phase-shifting algorithm facilitates accurate shape measurement at speeds of up to 3.4 times that of the traditional sinusoidal based technique of the prior art and discussed in detail above. The novel phase error compensation reduces measurement error in the inventive system and method by up to ten (10) times that of known phase error compensation functions. Moreover, the novel and more accurate camera and projector calibration provides for much more systematical, accurate and faster operation than known 3D shape measurement systems using video projectors.

### DESCRIPTION OF THE DRAWING FIGURES

FIG. 1 is a schematic diagram of a prior art structured light system for 3D measurement for implementing three-step sinusoidal-based, and/or trapezoidal phase-shifting functions;

FIGS. 2a, 2b and 2c depict a cross-section of a trapezoidal fringe pattern, an intensity ratio in a trapezoidal shape and an intensity-ratio ramp, respectively, for use in a three-step trapezoidal-based phase-shifting function of the prior art;

FIG. 3 depicts one embodiment of the novel structured light system 200 for 3D shape measurement;

FIGS. 4a, 4b and 4c, show the cross sections of the three phase-shifted sinusoidal patterns for α=120°, for use with the inventive system and method;

FIG. 5a depicts an intensity ratio image; FIG. 5b depicts an intensity ratio based on the FIG. 5a intensity ratio image;

FIG. 6a depicts a comparison of real and ideal intensity ratios;

FIG. 7 depicts a 2π range between −π/4 and 7π/4 is divided into four (4) regions: (−π/4, π/4), (π/4, 3π/4), (3π/4, 5π/4) and (5π/4, 7π/4), for fast arctangent processing of sub-function of the inventive system and method;

FIG. 8a depicts intensity ratio, r, with a normalized value between 0 and 1 for use in the fast arctangent sub-function;

FIG. 8b shows four phase angle regions used in the novel fast arctangent sub-processing sub function;

FIG. 8c shows phase angle calculated as φ=(π/2)(round ((N−1)/2)+(−1)^{N}(φ+δ) in the range of −π/4 to 7π/4 as shown in FIG. 8c;

FIG. 9 shows a typical diagram of a camera pinhole model;

FIG. 10a depicts a flat checkerboard pattern used to obtain the intrinsic parameters of the camera for novel calibration of the inventive system and method;

FIG. 10b depicts the checkerboard of FIG. 10a illuminated by white light;

FIG. 10c depicts the checkerboard illuminated with red light;

FIG. 11 depicts the checkerboard posed in ten (10) different positions of poses;

FIG. 12 is a set of vertical and horizontal pattern images, which together establish the correspondence between the camera and Projector images;

FIGS. 13a and 13b together depict an example of a camera checkerboard image converted to a corresponding projector “captured” image;

FIG. 14 depicts a checker square on the checkerboard with its corresponding camera image and projector image;

FIGS. 15a, 15b depict the origin and directions superimposed on the camera and projector images; and

FIG. 16 depicts a projection model based on a structured light system of the invention.

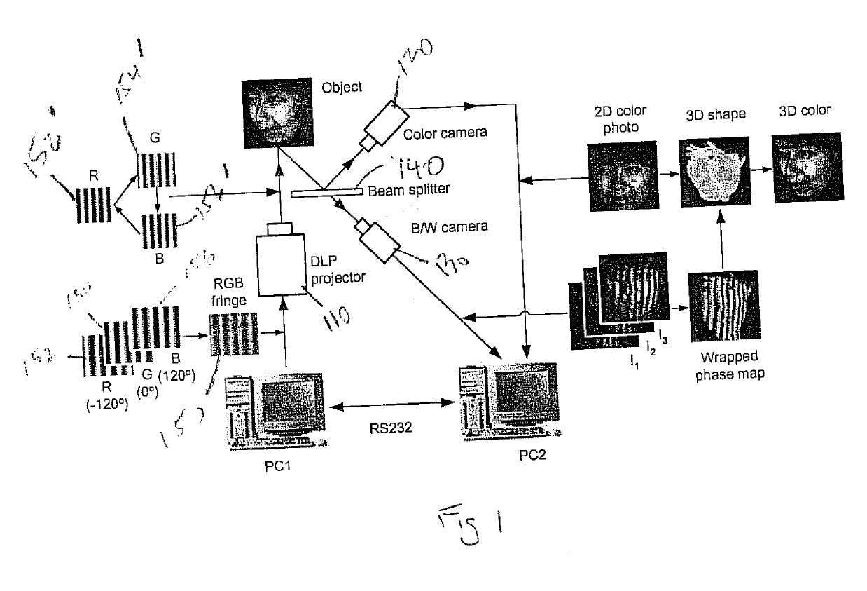

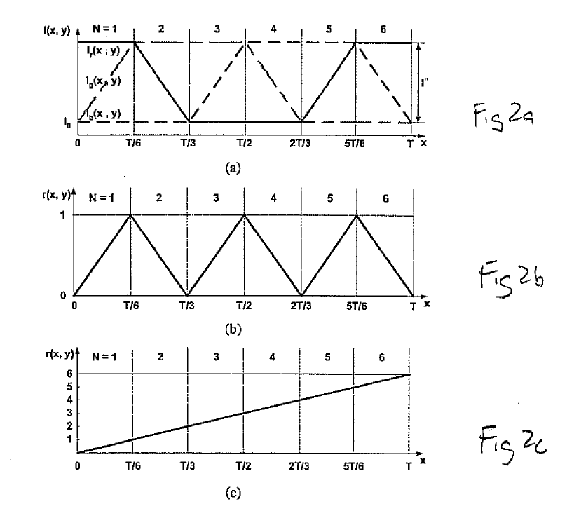

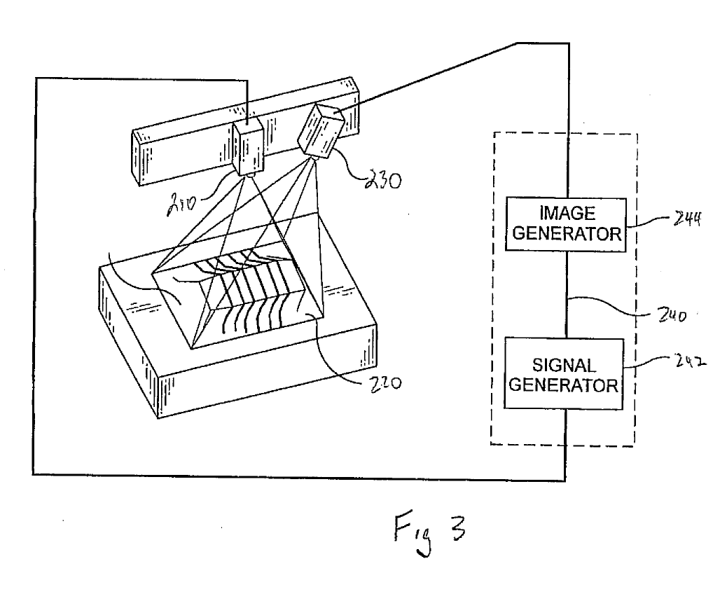

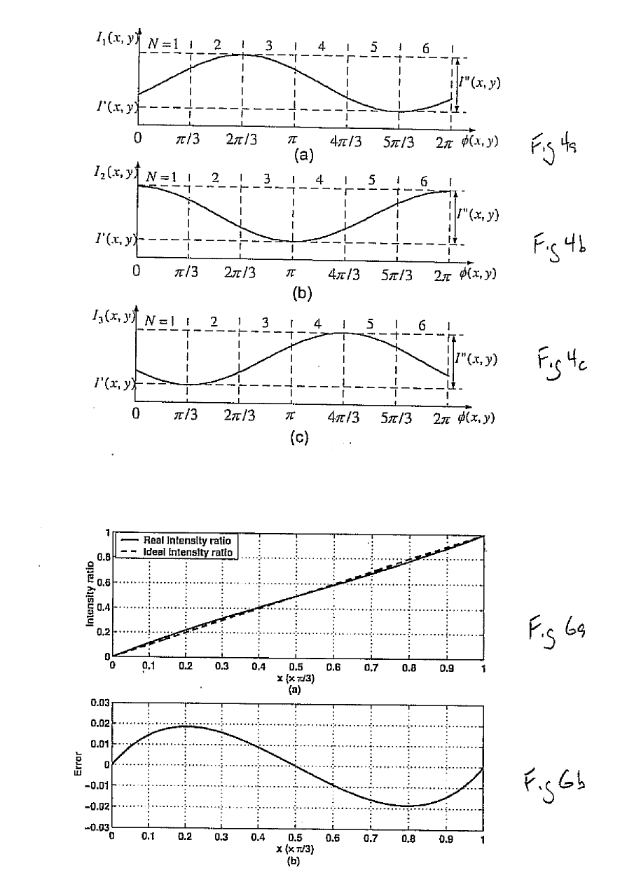

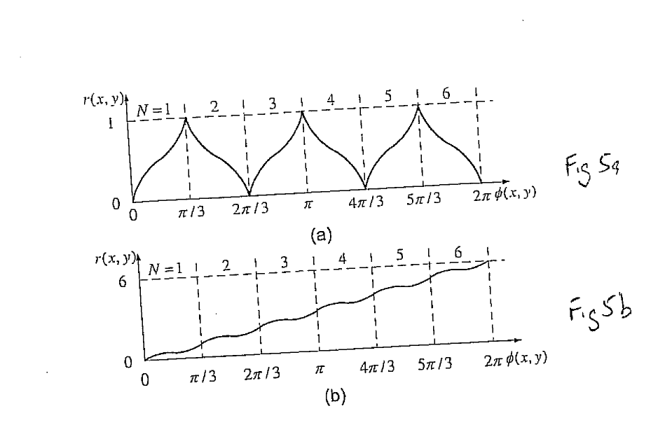

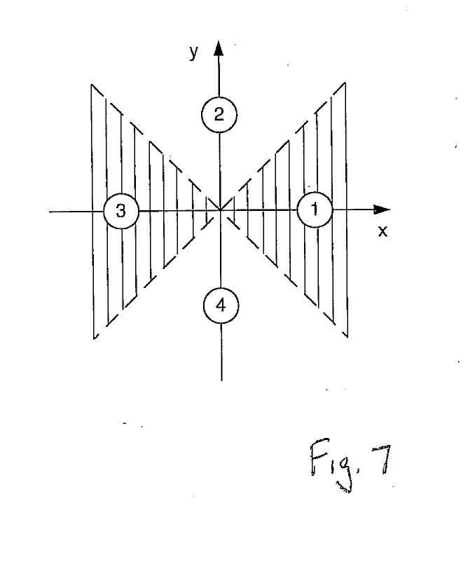

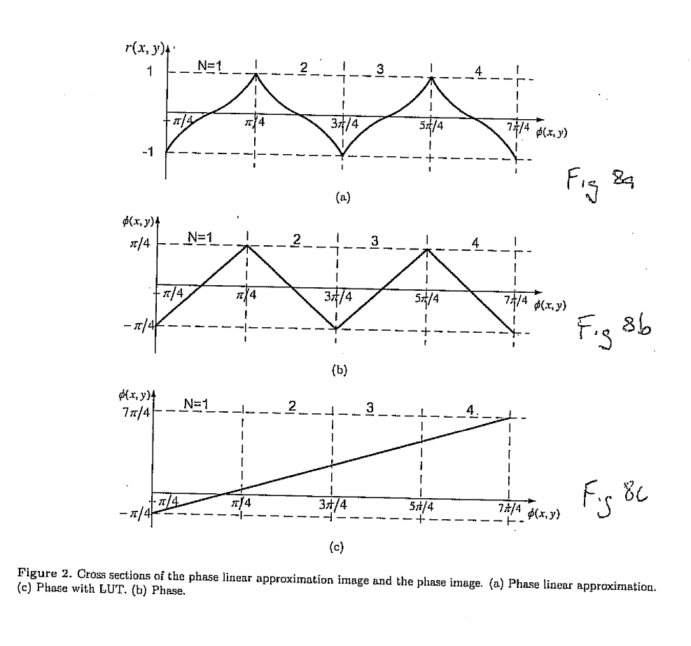

### DETAILED DESCRIPTION OF THE INVENTION

As mentioned above with respect to the prior art, phase-shifting techniques used in structured light systems for 3D shape measurement determine the phase values for fringe patterns in the range of 0 to 2π. Phase unwrapping is used for removing 2π discontinuities from the captured fringe patterns to generate a smooth phase map of the 3D object. Traditional phase-shifting functions, e.g., sinusoidal-based, require use of an arctangent function to use the data in the 3D measurement processing. This renders any computer-implemented phase-shifting function very operation intensive, slowing down overall processing time for 3D measurement. The present inventive structured light system and method are arranged to implement a novel phase-shifting in a function somewhat related to a prior art three-step trapezoidal-based function disclosed in the 2004 Zhang/Huang publication described above. Therein, the trapezoidal-based phase-shifting function uses an intensity ratio calculation instead of phase to avoid the use of the arctangent function and increase processing speeds, discussed in grater detail below with respect to error compensation. The novel trapezoidal-based three-step phase shifting function disclosed and claimed herein uses projected sinusoidal patterns in lieu of trapezoidal patterns in order to make more accurate error compensation. Using the novel trapezoidal-based phase-shifting and intensity-ratio function avoids possible defocus error known for traditional use with trapezoidal patterns, and is discussed in greater detail below in the section identified with the heading: Fast Three-Step Phase-Shifting.

While using the novel fast three-step phase shifting function has an advantage of fast processing speed, it also results in linear phase values becoming non-linear. A novel phase-error compensation function is also disclosed that compensates for the error, requiring use of a look up table (LUT). The phase error compensation function is discussed in detail in the section below identified with the section heading: Phase Error Compensation.

And as mentioned above with respect to the prior art, structured light systems differ from classic stereovision systems in that one of the two cameras or light capturing devices found in classical stereovision systems is replaced with a light pattern projector, or digital light pattern projector. Accurate reconstruction of 3D shapes using the novel structured light system are limited by the accuracy of the calibration of each element in the structured light system, i.e., the camera and projector. The present inventive structured light system is constructed such that the projector operates like a camera, but unlike related prior art systems, the camera and projector are calibrated independently. Accordingly, errors that might be cross-coupled between the projector and camera, or camera and projector using prior art, are avoided. The novel calibration function essentially unifies procedures for classic stereovision systems, and structured light systems, and uses a linear model with a small look-up table (LUT), discussed in detail in the section identified below as: Calibration.

FIG. 3 depicts one embodiment of the novel structured light system 200 for 3D shape measurement that can implement the novel sinusoidal-based three-step phase shifting using three patterns projected with sinusoid intensity modulation and processed with a fast arctangent sub-function, and with the novel trapezoidal-based three-step phase shifting utilizing sinusoidally modulated intensity projecting, and processing using an intensity ratio sub-function to avoid using arctangent in processing the captured patterns.

System 200 includes a projector 210 and B/W high speed camera 230 that communicate with a system processor 240. System processor 240 comprises a signal generator section 242 and an image generator section 244. The signal generator section 242 of system processor 240 generates the three fringe patterns and provides the patterns to projector 210 to project the patterns 220 to an object surface (the object is not part of the system), discussed in greater detail below. The image generator portion of system processor 240 processes the light patterns reflected from the object and captured by B/W camera 230 to generate reconstructed images. The system processor then implements the inventive processing to carry out the 3D shape measurement in real-time.

Fast Three-Step Phase-Shifting

Traditional phase-wrapping functions that use sinusoidal patterns require calculating arctangent function, which is very operation intensive, slowing down overall system processing time. As discussed above, prior art structured light system 100 substitutes a three-step trapezoidal-based phase shifting method for 3D shape measurement using trapezoidal fringe patterns. The trapezoidal-based phase-shifting uses intensity ratio instead of phase to calculate 3D shape and ranging with trapezoidal patterns. While doing so avoids using the arctangent function, it also adds defocus error because of the inherently square nature of the trapezoid. Two novel approaches are used herein, where the first approach implement a modified three-step trapezoidal-based function using sinusoidal patterns to obviate defocus error and includes an error compensation LUT. The second approach implements a fast arctangent calculation for use with more traditional sinusoidal based phase-shifting with sinusoidal patterns. Both novel approaches allow the processing to occur at rates that support measurement system operation in real-time.

In the first approach, the novel three-step phase-shifting operation includes projecting, capturing and processing sinusoidal fringe patterns using the known trapezoidal based method. As mentioned, this novel function uses an ratio-intensity sub-process or function, which eliminates the need for arctangent processing. The derivation of the novel function are relate to the following equations for intensity values that are phase dependent:
I₁(x,y)=I′(x,y)+I″(x,y)cos[φ(x,y)−α],
I₂(x,y)=I′(x,y)+I″(x,y)cos[φ(x,y)], and
I₃(x,y)=I′(x,y)+I″(x,y)cos[φ(x,y)+α],
where I′(x,y) is the average intensity, I″(x,y) is the intensity modulation, and φ(x,y) is the phase to be determined. Even though α may take on any value, the two commonly used values are α=90° and α=120°, where the novel function used in the inventive method and structured light system for 3D shape measurement 200 use the case where α=120°. FIGS. 4a, 4b and 4c, show the cross sections of the three phase-shifted sinusoidal patterns for α=120°. Solving the three equations simultaneously for the phase φ(x,y) realizes:
φ(x,y)=arctan[(3)^{1/2}(I₁−I₃)/(2I₂−I₃)].
But as mentioned above, using computers to calculate arctangent is quite slow, leading to development of the prior art trapezoidal-based three-step phase-shifting with trapezoidal patterns. And as mentioned above, while the conventional trapezoidal-based method, which uses trapezoidal fringe patterns, increases the calculation speed for the 3D shape measurement it imparts error due to image defocus, depending on shape variations. To remedy or avoid this inherent defocus error, the novel inventive phase-shifting function allies the trapezoidal-based phase-shifting function to sinusoidal patterns. The novel and non-intuitive use of the sinusoidal fringe patterns is based on a perspective that considers the sinusoidal patterns as maximally defocused trapezoidal patterns. The defocus error is therefore fixed, and may be readily compensated.

By dividing the sinusoidal period evenly into six regions (N=0, 1, . . . , 5), each region covers an angular range of 60°. There is no crossover within each of regions. The three intensity values are thereafter denoted as Iₗ(x,y), Iₘ(x,y), and Iₕ(x,y), which are low, medium and high intensity values, respectively. From the intensity values, an intensity ratio is calculated in accordance with the following:
r(x,y)=(Iₘ(x,y)−Iₗ(x,y))/(Iₕ(x,y)−Iₗ(x,y)),
which has a normalized value between 0 and 1, as shown in an intensity ratio image of FIG. 5a, where the intensity ratio is shown in FIG. 5b. The phase may be calculated from the intensity ratios without use of the arctangent function using the following equation:
φ(x,y)=π/3[2×round(N/2)+(−1)^{N}r(x,y)],
which value ranges from 0 to 2π. The phase calculation is somewhat inaccurate, as can be seen in the intensity ratio of FIG. 6a, and error plot of FIG. 6b, which is compensated for in accord with the description in the below section on Phase Error Compensation. Where multiple fringes are used, the phase calculated as such results in a saw-tooth-like shape requiring traditional phase-unwrapping as discussed above.

Before moving on to the error compensation, the second novel approach will be described referred to herein as using a fast arctangent sub-function. The fast-arctangent function may be utilized in any sinusoidal-based phase-shifting algorithms, such as three-step, four-step, Carré, Hariharan, least-square, Averaging 3+3, 2+1, etc., to increase the processing speed. The principle behind use of the fast arctangent function, or sub-function, lies in its ability to approximate the arctangent using a ratio function. To do so, a 2π range between −π/4 and 7π/4 is divided into four (4) regions: (−π/4, π/4), (π/4, 3π/4), (3π/4, 5π/4) and (5π/4, 7π/4), as shown in FIG. 7. In each region, the arctangent sub-function arctan(y/x) is calculated as a ratio function as follows:

$$\begin{matrix}r = \{ x / y , when \vert x \vert < \vert y \vert , \\ \{ y / x , otherwise .\end{matrix}$$

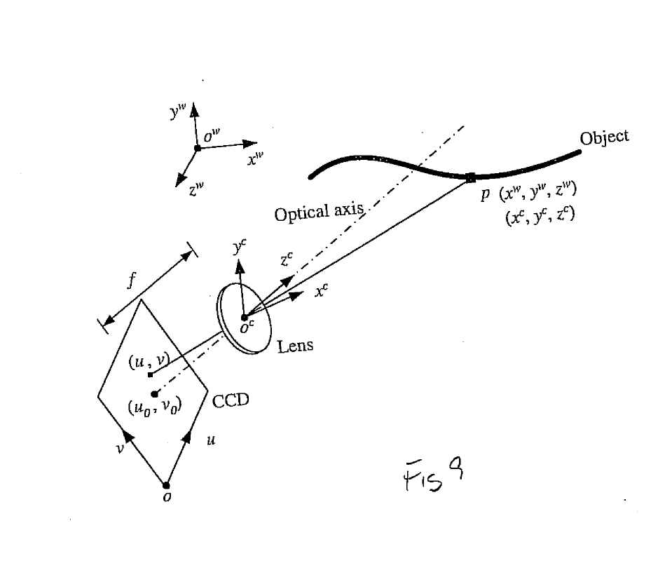

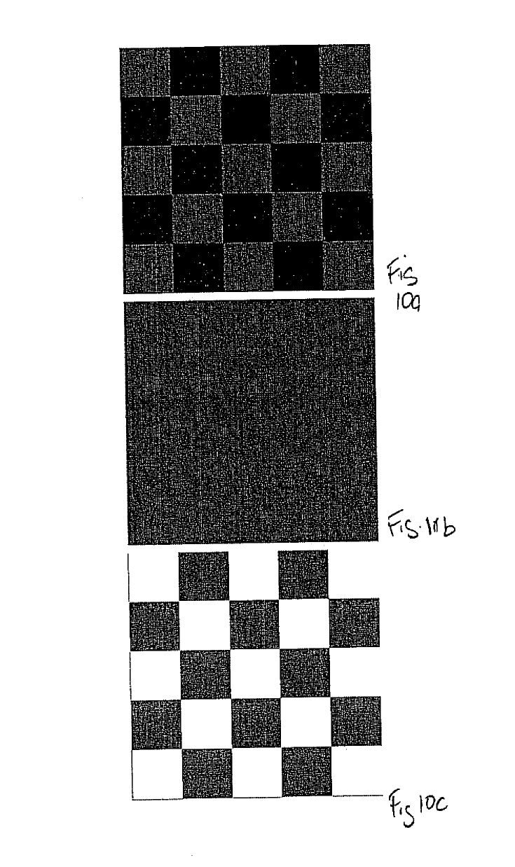

The intensity ratio, r, therefore, takes on a value between −1 and 1 as seen in FIG. 8a. In region 1 and 3, where N=1, and 3, |x|<|y| and in region 2 and 4, where N=2, and 4, |x|≧y. In region 1, the approximate phase is:
˜φ=πr/4,
and the real phase is then:
φ=˜φ=δ,
where δ can be written as a function of the approximate phase ˜φ, as:
δ(˜φ)=tan⁻¹(4˜φ/π)−˜φ,
The value for δ(˜φ) may be pre-computed and stored in a LUT for phase error compensation. Since the four regions share the same characteristics, the same LUT may be applied to the other regions. The phase may be calculated thereby using a direct ratio calculation. The phase calculated in the four phase angle regions after phase error compensation is shown in FIG. 8b. The triangular shape can be removed by detecting the region number N for each point, and the region number may be determined by the sign and relative absolute values of y=Sin(φ) and x=cos(φ). The phase in the entire 2π range (−π/4 to 7π/4) is then:
φ=(π/2)(round((N−1)/2)+(−1)^{N}(˜φ+δ),
as shown in FIG. 8c. Adoption of the fast arctangent sub-function is found to be 3.4 times as fast as directly calculating arctan, and when implemented in a sinusoidal-based three-step phase-shifting, successful high-resolution, real-time 3D shape measurement may be carried out in novel structured light system 200 at a speed of 40 frames/second, which is true real-time (where each frame is 532×500 pixels).
Phase Error Compensation

While the inventive trapezoidal-based three-step phase-shifting function used with sinusoidal fringe patterns has the advantage of faster processing speed for true real-time 3D shape measurement, the resulting phase φ(x,y) includes non-linear error, as shown in FIGS. 6a and 6b (mentioned above). FIG. 6a depicts the real and ideal intensity values, and FIG. 6b depicts the error in the first of the six (6) regions. The error associated with the non-linear phase values is periodical, with a pitch of π/3 as shown, therefore, need only be analyzed in one period, or φ(x,y)ε[0, π/3]. By substitution, r(φ) is obtained as:
r(φ)=(I₁−I₃)/(I₂−I₃)=½+((3^{1/2})/2)tan(φ−π/6).
The right-hand side of the equation may be considered the sum of the linear and non-linear terms. It follows that r(φ)=φ/(π/3)+Δr(φ), where the first term represents the linear relationship between r(x,y) and φ(x,y), and the second term Δr(x,y) is the nonlinearity error. The non-linearity error may be calculated as follows,
Δr(φ)=r(φ)−φ/(π/3)=½+((3^{1/2})/2)tan(φ−π/6)−φ/(π/3).
By taking the derivative of Δr(x,y) with respect to φ(x,y), and setting it to 0, we can determine that when
φ_{1,2}=π/6±(cos)⁻¹((3)^{1/2}/6)^{1/2}),
the error reaches its maximum and minimum values, respectively as:
Δr(φ)ₘₐₓ=Δr(φ₁)=0.0186,
Δr(φ)ₘᵢₙ=Δr(φ₂)=−0.0186.
The maximum ratio error is therefore Δr(φ)ₘₐₓ−Δr(φ)ₘᵢₙ=0.0372. And because the maximum ratio value for the whole period is 6, the maximum ratio error in terms of percentage is 0.0372/6, or 0.62%. To compensate for his small error, a look-up table is used, constructed with 256 elements that represent the error values determined by r(φ). If a higher-bit-dept camera is used, the size of the LUT is increased accordingly. Moreover, because of the periodic nature of the error, the same LUT may be applied to all six regions
Calibration

The inventive structured light system 200, and three-step sinusoidal-based phase-shifting method including the novel fast arctangent function, or the trapezoidal-based phase-shifting function using sinusoidal fringe patterns, further includes a function for fast and accurate calibration. The function arranges for a projector to capture images like a camera, where the projector and camera, or cameras included in the system are calibrated independently. By doing so, this avoids inherent problems in the prior art systems where the calibration accuracy of such a projector may be affected by the error of the camera.

In greater detail, cameras are often defined by a pinhole model by combined intrinsic and extrinsic parameters. Intrinsic parameters include focal length, principal point, pixel size and pixel skew factors. Extrinsic parameters include rotation and translation from a world coordinate system to the camera coordinate system. FIG. 9 shows a typical diagram of a camera pinhole model, where p is an arbitrary point with (x^{w}, y^{w}, z^{w}) and (x^{c}, y^{c}, z^{c}) in the world coordinate system {o^{w}; x^{w}, y^{w}, z^{w}} and camera coordinate system {o^{c}; x^{c}, y^{c}, z^{c}}, respectively. The coordinate of its projection in the image plane {o; u, v} is (u,v). The relationship between a point on the object and its projection on the image sensor may be described as follows based on a projection model:
sI=A[R,t]X^{w},
where I={u, v, 1}^{T}, which is the homogeneous coordinate of the image point in image coordinate system, X^{w}={x^{w}, y^{w}, z^{w}, 1}^{T} is the homogenous coordinate of the point in the world coordinate system, and “s” is a scale factor. [R, t] is the extrinsic parameter matrix, which represents the rotation and translation between the world coordinate system and the camera coordinate system. “A” is a matrix representing the camera intrinsic parameters.

$$A = \vert \begin{matrix}α & γ & {u}_{0} \\ 0 & β & {v}_{0} \\ 0 & 0 & 1\end{matrix} \vert ,$$

where (u₀,v₀) is the coordinate of the principle point, α and β are the focal lengths along the u and v axes of the image plane, and γ is the parameter that describes the skewness of the two image axes. The projection model described above represents a linear model of a camera.

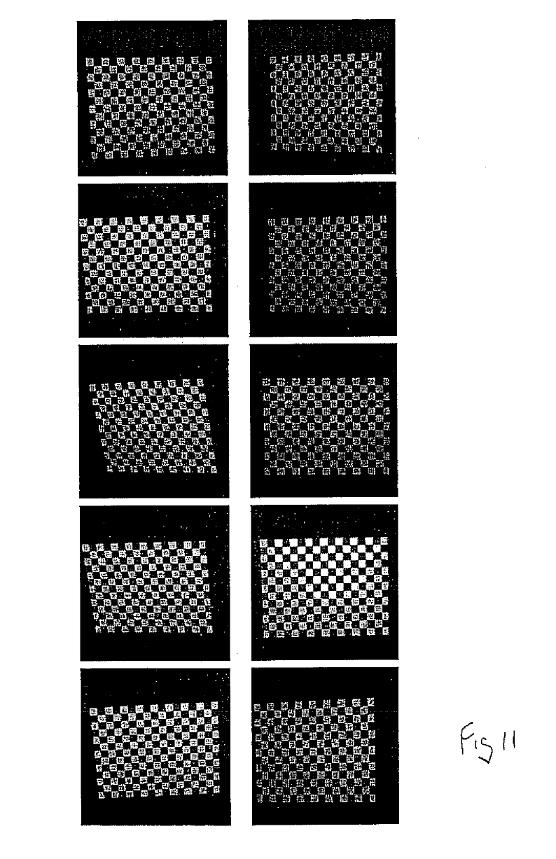

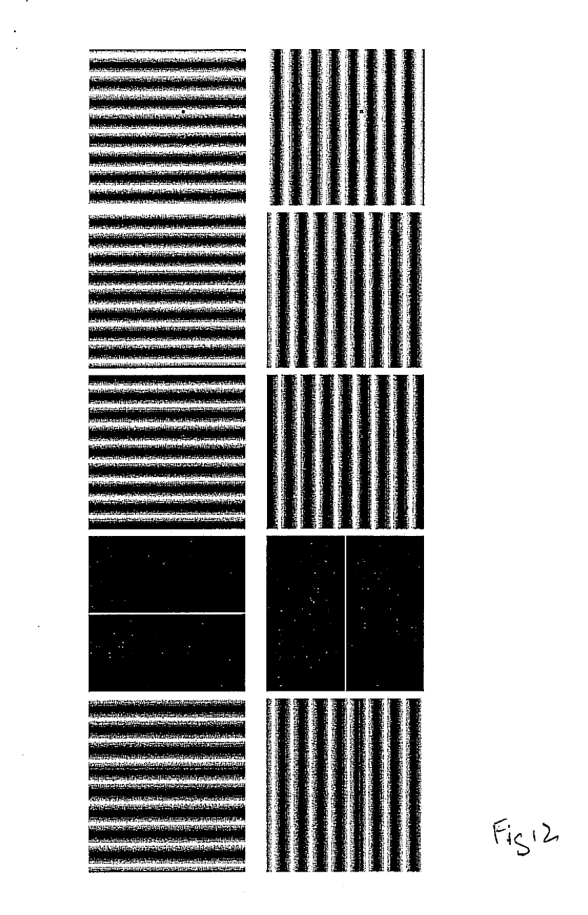

To obtain the intrinsic parameters of the camera, a flat checkerboard is used, as can be seen in FIG. 10a. FIG. 10a shows a red/blue checkerboard having a size of 15×15 mm for each square, which is used in a novel sub-process explained in grater detail below. The checkerboard is posed in ten (1) different positions of poses, as seen in FIG. 11, and a mathematical application program such as the Matlab™ Toolbox for Camera Calibration is used to obtain the camera's intrinsic parameters in accord with the linear model. For a Dalsa CA-D6-0512, with a 25 mm lens (Fuijinon HF25HA-1B), the intrinsic parameters were calculated as:

$${A}^{c} = \vert \begin{matrix}25.8031 & 0 & 2.7962 \\ 0 & 25.7786 & 2.4586 \\ 0 & 0 & 1\end{matrix} \vert , mm$$

where the principle point was found to deviate from the CCD center.

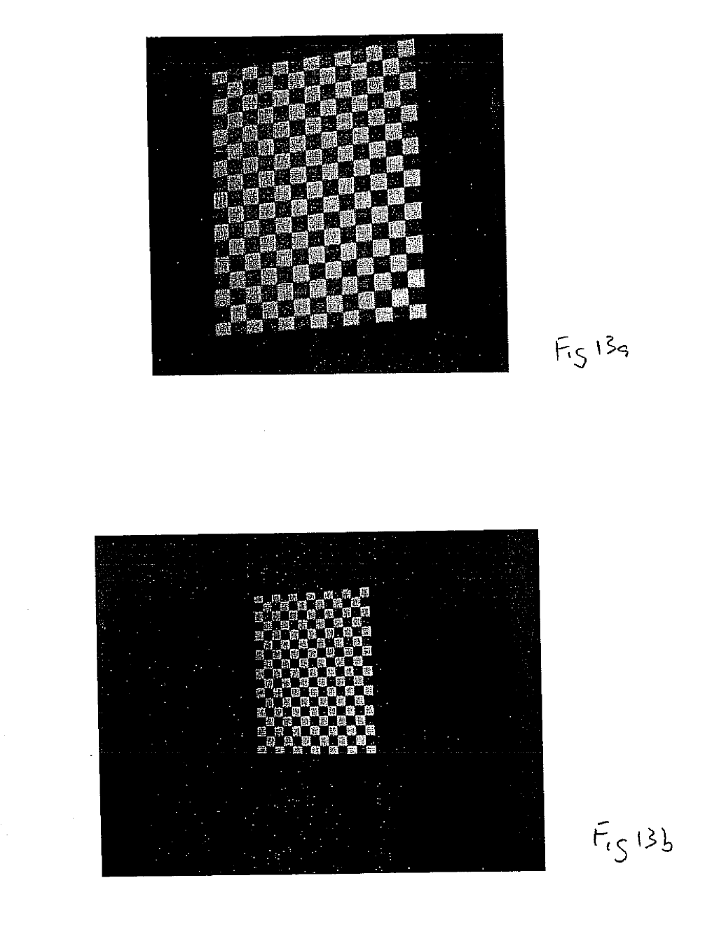

A projector may be considered to be an inversed camera in that it projects rather than captures images. The novel structured light system 200 includes projector 210, and the novel calibration function treats the projector as if it were a camera. Where a second camera is included in system 200, the second camera must be calibrated to the first camera, after camera projector calibration, whereby both cameras are calibrated to the projector. The “camera-captured” images may then be transformed into projector images in the projector, as if provided by the projection chip in normal projector projection operation. To generate the projector image from the camera-captured image requires defining a correspondence between the camera pixels and projector pixels. Defining the correspondence between the camera pixels and projector pixels requires recording a series of phase-shifted sinusoidal fringe patterns with the camera to obtain phase information for every pixel captured. As was seen above, the intensities of three images with a phase shift of 120 degrees is calculated as:
I₁(x,y)=I′(x,y)+I″(x,y)cos[φ(x,y)−α],
I₂(x,y)=I′(x,y)+I″(x,y)cos[φ(x,y)], and
I₃(x,y)=I′(x,y)+I″(x,y)cos[φ(x,y)+α],
where α is 2π/3, I′(x,y) is the average intensity, I″(x,y) is the intensity modulation, and φ(x,y) is the phase to be determined. For α=120°, solving the three equations simultaneously for φ(x,y) realizes:
φ(x,y)=arctan[(3)^{1/2}(I₁−I₃)/(2I₂−I₁−I₃)].
The equation provides the modulo 2π phase at each pixel where the pixel's value ranges from 0 to 2π. The 2π discontinuity is removed using a phase-unwrapping function to obtain a continuous 3D map. The phase map is relative, so converting the map to absolute phase requires capturing a centerline image. A centerline image is a bright line on the center of a digital micro-mirror device (DMD) chip in the projector. Assuming a phase value of 0, the relative phase is converted to absolute phase, corresponding to one unique line on the projected image that includes the generated fringe patterns. The function then computes the average phase from the fringe images at the centerline position using the following equation:
Φ₀=(Σ^{N}ₙ₌₀φn(i,j)/N,
where N is the number of pixels on the centerline. The conversion to absolute phase is calculated by:
φₙ(i,j)=φ(i,j)−Φ₀.
The calibration function then transfers or maps the camera image to the projector pixel-by-pixel to form the “captured” checkerboard-pattern image. FIG. 12 is a set of vertical and horizontal pattern images, which together establish the correspondence between the camera and projector images. The red point included in the upper left three fringe images is an arbitrary point whose absolute phase is determined by the above-described equations. Based on the phase value, one corresponding straight line is identified in the projector image, which is the horizontal red line shown in the last image of the upper row of FIG. 12. The mapping is a one-to-many mapping. The same process is carried out on the vertical fringe images in the second row of FIG. 12 to create another one-to-many mapping. The same point on the camera images is mapped to a vertical line in the projector image as shown. The intersection point of the horizontal line and the vertical line is the corresponding point on the projector image, of the arbitrary point on the camera image. This process may be used to transfer the camera image, point by point, to the projector to form the “captured” image for the projector.

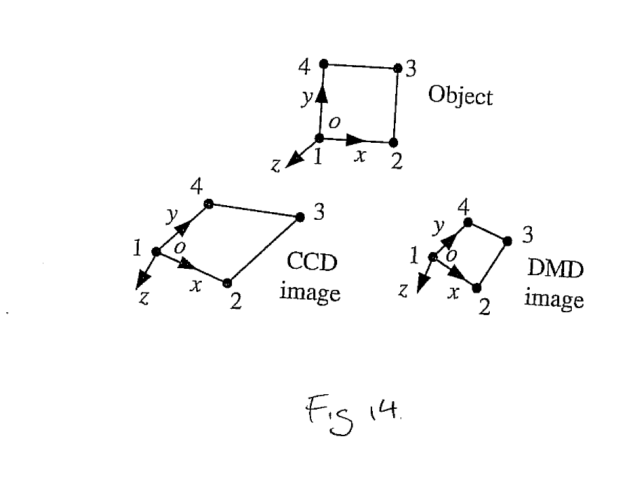

As mentioned briefly above, a B/W checkerboard is not used in the camera calibration since the fringe images captured by the camera show too large of a contrast between the areas of the black and white squares, which can cause significant errors in determining the pixel correspondence between the camera and the projector. To accommodate, a red/blue checkerboard pattern illustrated in FIG. 10a is used. Because the responses to the B/W camera to red and blue colors are similar, the B/W camera can see only a uniform board (ideally), if the checkerboard is illuminated by white light (FIG. 10b). When the checkerboard is illuminated with red or blue light, the B/W camera will see a regular checkerboard. As an example, FIG. 10c shows the checkerboard illuminated with red light. The red and blue colors are used because they provide the best contrast when the checkerboard is illuminated by either a red or blue light. Other colors, such as red and green, or green and blue, can also be used. Moreover, other means that allow the checkerboard pattern to be turned on and off, for example, ink paper or other flat displays, can also be used for the same purpose. FIGS. 13a and 13b show an example of a camera checkerboard image converted to a corresponding projector “captured” image. In particular, FIG. 13a shows the checkerboard image captured by the camera with red light illumination, while FIG. 13b shows the corresponding projector image.

After a set of projector images are generated or “captured”, the calibration of the intrinsic parameters of the projector can follow that of the camera, but independently, without the shortcomings of the prior art as discussed above. The following matrix defines the intrinsic parameters of a projector (PLUS U2-1200), having a DMD with a resolution of 1024×768 pixels, and a micro-mirror size of 13.6×13.6 μm.

$${A}^{p} = \vert \begin{matrix}31.1384 & 0 & 6.7586 \\ 0 & 31.1918 & - 0.1806 \\ 0 & 0 & 1\end{matrix} \vert .$$

It can be seen that the principle point deviates from the nominal center significantly in one direction, even outside the DMD chip. This deviation is understood to be due to the projector design arranged to project images along an off-axis direction.

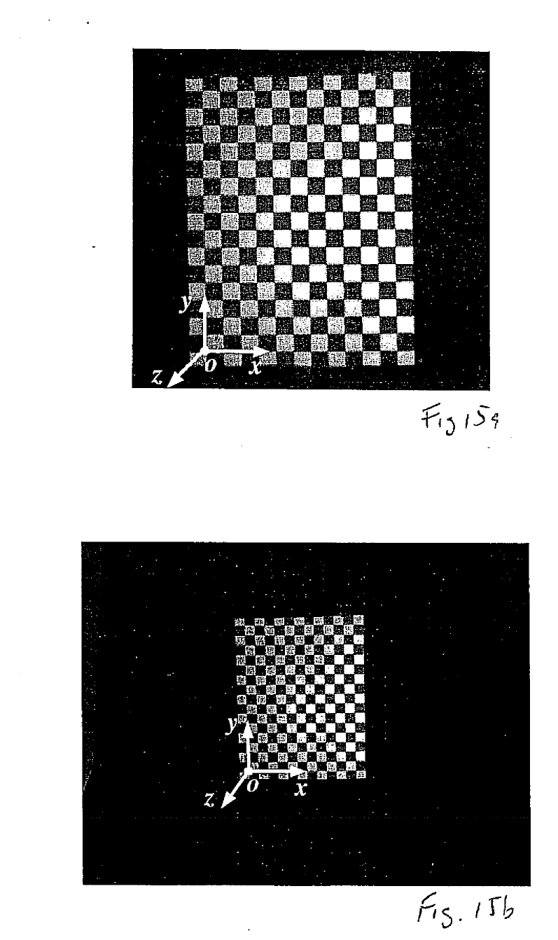

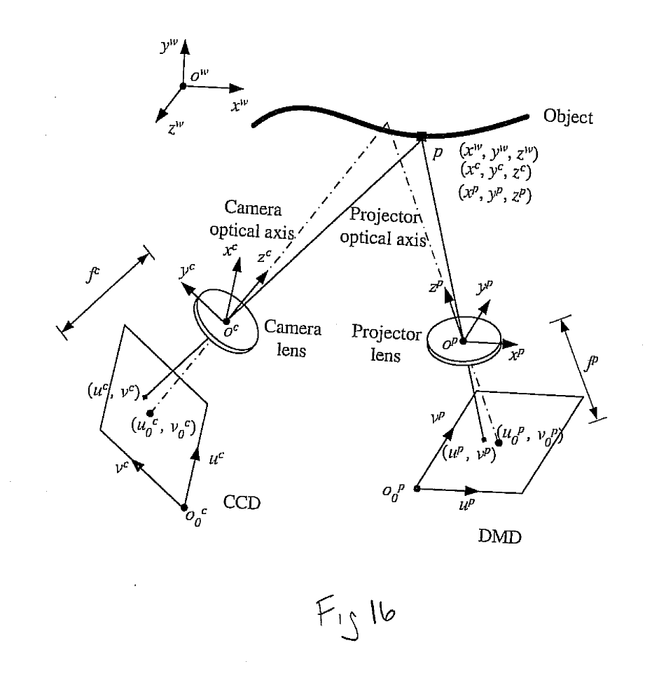

With the intrinsic parameters of the camera and projector calibrated, the extrinsic system parameters are calibrated. This includes establishing a unique world coordinate system for the camera and projector in accord with one calibration image set. The calibration image set is arranged with its x and y axes on the plane, and its z-axis perpendicular to the plane and pointing towards the system. FIG. 14 shows a checker square on the checkerboard with its corresponding camera image and projector image. The four corners of the square, 1, 2, 3, and 4, are imaged onto the CCD and DMD, respectively, where 1 is defined as the origin of the world coordinate system. The direction from 1 to 2 is defined as the positive x direction, and the direction from 1 to 4 as the positive y direction. The z-axis is defined based on the right-hand rule in Euclidian space. FIGS. 15a, 15b shows the origin and directions superimposed on the camera and projector images.

The relationship between the camera and world coordinate systems are expressed as follows:
X^{c}=M^{c}X^{w},
where M^{c}=[R^{c},t^{c}] is the transformation matrix, M^{p}=[R^{p},t^{P}] is the transformation matrix between the projector and world coordinate systems, and X^{c}={x^{c}, y^{c}, z^{c}}^{T}, X^{p}={x^{p}, y^{p}, z^{p}}^{T}, and X^{w}={x^{w}, y^{w}, z^{w}, 1}^{T} are the coordinate matrices for point 6 in the camera, projector and world coordinate systems, respectively. X^{c} and X^{p} can be further transformed to their camera and projector image coordinates (u^{c}, v^{c}) and (u^{p}, v^{p}) by applying the intrinsic matrices A^{c} and A^{p} because the intrinsic parameters are known.
s^{c}{u^{c},v^{c},1}^{T}=A_{c}X^{c},
s^{p}{u^{p},v^{p},1}^{T}=AₚX^{p},

The extrinsic parameters are obtained by using only one calibration image. Again, the Matlab Toolbox for Camera Calibration may be used to obtain the extrinsic parameters for the system set-up:

$${M}^{c} = \vert \begin{matrix}0.0163 & 0.9997 & - 0.0161 & - 103.4354 \\ 0.9993 & - 0.0158 & 0.0325 & - 108.1951 \\ 0.0322 & - 0.0166 & - 0.9993 & 1493.0794\end{matrix} \vert$$

$${M}^{p} = \vert \begin{matrix}0.0197 & 0.9996 & - 0.0192 & - 82.0873 \\ 0.9916 & - 0.0171 & 0.1281 & 131.5616 \\ 0.1277 & - 0.0216 & - 0.9915 & 1514.1642\end{matrix} \vert$$

Real measured object coordinates are obtained based on the calibrated intrinsic and extrinsic parameters of the camera and projector. Three phase-shifted fringe images and a centerline image are used to reconstruct the geometry of the surface. To solve for the phase-to-coordinate conversion based on the four images, the absolute phase for each arbitrary point (u^{c}, v^{c}) on the camera image plane is first calculated. This absolute phase value is then used to identify a line on the DMD having the same absolute phase value. Without loss of generality, the line is assumed to be a vertical line within u^{p}ξ(φₙ(u^{c}, v^{c})). Assuming the world coordinates of the point to be (x^{w}, y^{w}, z^{w}), the following equation will transform the world coordinates to the camera image coordinates.
s^{c}{u^{c}v^{c}1}^{T}=P^{c}{x^{w}y^{w}z^{w}1}^{T},
where P^{c}=A^{c}M^{c}, the calibrated matrix for the camera. Similarly, the coordinate transformation for the projector follows:
s^{p}{u^{p}v^{p}1}^{T}=P^{p}={x^{w}y^{w}z^{w}1}^{T},
where P^{p}=A^{p}M^{p}, the calibrated matrix for the projector. By manipulating the calibrated camera and projector coordinate transforms, the following three linear equations may be derived:
f₁(x^{w}y^{w}z^{w}u^{c})=0,
f₂(x^{w}y^{w}z^{w}v^{c})=0,
f₃(x^{w}y^{w}z^{w}u^{p})=0.
where u^{c}, v^{c} and u^{p} are known. The world coordinates (x^{w} y^{w} z^{w}), therefore, of the point p can be uniquely solved for the image point (u^{c} v^{c}), as can be seen in the projection model of FIG. 16 based on a structured light system of the invention.

1. A structured light system for object ranging/measurement that implements a trapezoidal-based phase-shifting function with intensity ratio modeling using sinusoidal intensity-varied fringe patterns to accommodate for defocus error, comprising:
a light projector constructed to project at least three sinusoidal intensity-varied fringe patterns onto an object that are each phase shifted with respect to the others;
a camera included for capturing the at least three intensity-varied phase-shifted fringe patterns as they are reflected from the object; and
a system processor in electrical communication with the light projector and camera for generating the at least three fringe patterns, shifting the patterns in phase and providing the patterns to the projector, wherein the projector projects the at least three phase-shifted fringe patterns sequentially, wherein the camera captures the patterns as reflected from the object and wherein the system processor processes the captured patterns for object ranging/measurement.

2. The structured light system as set forth in claim 1, wherein each of the at least three phase-shifted patterns is generated in a different color, and wherein the projector is set to project the at least three patterns in gray scale.

3. The structured light system as set forth in claim 2, wherein the projector is a digital light processing (DLP) projector which projects the patterns at channel switching frequency of the projector (for example, 360 Hz), the camera is a high speed camera able to capture the patterns at up to the channel switching frequency of the projector, and the system processor processes the captured patterns and carries out object measurement processing at real-time speed (>30 Hz).

4. The structured light system as set forth in claim 3, wherein the high-speed camera is a black and white (B/W) camera.

5. The structured light system as set forth in claim 1, wherein the sinusoidal intensity-varied phase-shifted patterns are utilized in the trapezoidal-based function to mimic a defocused trapezoidal pattern to compensate for defocus error incurred when the patterns are projected by the projector and captured by the camera.

6. The structured light system as set forth in claim 5, wherein the system processor generates and uses an intensity-ratio look-up table (LUT) to compensate for phase error.

7. The structured light system as set forth in claim 1, wherein the phase shifting is three-step, the system uses three patterns generated in red (R), green (G) and blue (B) and the processor calculates three intensity values as:
I₁(x,y)=I′(x,y)+I″(x,y)cos[φ(x,y)−α],
I₂(x,y)=I′(x,y)+I″(x,y)cos[φ(x,y)], and
I₃(x,y)=I′(x,y)+I″(x,y)cos[φ(x,y)+α],
where α represents a 2π/3 phase shift among the three patterns.

8. The structured light system as set forth in claim 7, wherein the processor calculates phase as:
φ(x,y)=arctan[(3)^{1/2}(I₁−I₃)/(2I₂−I₁−I₃)].

9. The structured light system as set forth in claim 8, wherein the processor calculates intensity ratio as:
r(x,y)=(I₂(x,y)−I₁(x,y))/(I₃(x,y)−I₁(x,y))

10. The structured light system as set forth in claim 9, wherein the intensity ratio is modeled to avoid processing using the arctan function by the system processor, the model embodying the following ratio calculation:
r=X/Y, when |X|<|Y|, and r=Y/X, otherwise.

11. The structured light system as set forth in claim 10, wherein the processor, camera and projector operate to carry out 3D object ranging/measurement in real time.

12. The structured light system as set forth in claim 10, wherein the processor derives the phase error over an entire 2π period (Only need to calculate and store the phase error in one region. The error is repeatable), storing calculated phase error compensation in a look-up table (LUT) for processor use.

13. The structured light system as set forth in claim 1, further comprising a second camera constructed for color imaging and arranged to capture a color image of the object for texture mapping by the processor.

14. The structured light system as set forth in claim 13, further comprising an optical beam splitter.

15. A structured light system for object ranging/measurement that implements a sinusoidal-based phase shifting function using at least three sinusoidal intensity-varied fringe patterns and a fast arctangent sub-function, the system comprising:
a light projector constructed to project the at least three fringe patterns onto a object such that each of the patterns are shifted in phase with respect to the others;
a camera included for capturing the fringe patterns as they are reflected from the object; and
a system processor in electrical communication with the projector and camera for generating the at least three intensity-varied fringe patterns, shifting the fringe patterns in phase and providing the phase-shifted patterns for sequential projection by the projector, wherein the camera captures and the system processor processes the captured patterns for object ranging/measurement.

16. The structured light system as set forth in claim 15, wherein each of the at least three phase-shifted patterns is generated in a different color, and wherein the projector is set to project the at least three patterns in gray scale.

17. The structured light system as set forth in claim 16, wherein the projector is a digital light processing (DLP) projector which projects the patterns at channel switching frequency of the projector (i.e., 360 Hz), the camera is a high speed camera able to capture the patterns at the channel switching frequency of the projector, and the system processor processes the captured patterns and carries out object measurement processing at real-time speeds (>30 Hz).

18. The structured light system as set forth in claim 17, wherein the high-speed camera is a black and white (BMW) camera.

19. The structured light system as set forth in claim 18, wherein the phase shifting is three-step, the system uses three patterns generated in red (R), green (G) and blue (B), wherein the processor calculates three intensity values as:
I₁(x,y)=I′(x,y)+I″(x,y)cos[φ(x,y)−α],
I₂(x,y)=I′(x,y)+I″(x,y)cos[φ(x,y)], and
I₃(x,y)=I′(x,y)+I″(x,y)cos[φ(x,y)+α],
where α represents a 2π/3 phase shift among the three patterns.

20. The structured light system as set forth in claim 19, wherein the processor calculates phase as:
φ(x,y)=arctan[(3)^{1/2}(I₁−I₃)/(2I₂−I₁−I₃)].

21. The structured light system as set forth in claim 18, wherein the processor, camera and projector operate to carry out 3D object ranging/measurement in real time.

22. The structured light system as set forth in claim 15, further comprising a second camera constructed for color imaging and arranged to capture a color image of the object for object texture mapping by the processor.

23. The structured light system as set forth in claim 2, wherein the phase is approximated by the following:
φ=(π/2)(round((N−1)/2)+(−1)^{N}(˜φ+δ).

24. The structured light system as set forth in claim 23, wherein the process computes 3D object measurement using the fast arctangent function at a speed of 40 frames/second with each frame comprising 532×500 pixels.

25. The structured light system as set forth in claim 15, wherein the system processor controls conducting a pre-processing calibration function to calibrate the projector to the camera prior to object measurement processing.

26. The structured light system as set forth in claim 1, wherein the system processor controls conducting a pre-processing calibration function to calibrate the projector to the camera prior to object measurement processing.

27. The structured light system as set forth in claim 25, wherein the pre-processing calibration function includes generating three B/W phase-shifted horizontal fringe pattern, and a horizontal centerline pattern, and three B/W phase-shifted vertical fringe patterns and a vertical centerline pattern, wherein the horizontal and vertical patterns are projected with varied sinusoidal phase to a checkerboard using colored light, wherein the camera captures the horizontal, vertical and centerline reflected from the checkerboard and the processor (?) transforms the images to appear to be captured by the projector and define a calibrated one-to-one correspondence between the image field and the projection field.

28. The structured light system as set forth in claim 26, wherein the pre-processing calibration function includes generating three B/W phase-shifted horizontal fringe pattern, and a horizontal centerline pattern, and three B/W phase-shifted vertical fringe patterns and a vertical centerline pattern, wherein the horizontal and vertical patterns are projected with varied sinusoidal phase to a checkerboard using colored light, wherein the camera captures the horizontal, vertical and centerline reflected from the checkerboard and the processes transforms tile images to appear to be captured by the projector and define a calibrated one-to-one correspondence between the image field and the projection field.

29. The structured light system as set forth in claim 27, wherein object coordinates are obtained based on calibrated intrinsic and extrinsic parameters.

30. The structured light system as set forth in claim 28, wherein object coordinates are obtained based on calculated intrinsic and extrinsic parameters.

31. The structured light system as set forth in claim 30, wherein world coordinates of each pixel calculated using the calibration function are designated by (x^{w}, y^{w}, z^{w}), world coordinates are transformed to the camera image coordinates by:
s{u^{c}v^{c}1}^{T}=P^{c}{x^{w}y^{w}z^{w}1}^{T},
where P^{c}=A^{c}M^{c}, the world coordinates are transformed to the projector “captured” image coordinates by:
s{u^{p}v^{p}1}^{t}=P^{p}{x^{w}y^{w}z^{w}1}^{T}, and where P^{p}=A^{p}M^{p}.

32. The structured light system as set forth in claim 31, wherein object coordinates in the world coordinate system (x^{w}, y^{w}, z^{w}) are solved using the following three linear equations:
f₁(x^{w}y^{w}z^{w}u^{c})=0,
f₂(x^{w}y^{w}z^{w}v^{c})=0,
f₃(x^{w}y^{w}z^{w}u^{p})=0,
to uniquely solve the world coordinates for each pixel (u^{c}, v^{c}).

33. A computer-based system for carrying out object ranging/measurement by executing a set of computer-related instructions that implement a three-step trapezoidal-based phase-shifting method using sinusoidal intensity-varying patterns, the method comprising steps of:
generating three sinusoidal fringe patterns with a phase shift of 2π/3;
projecting the phase-shifted fringe patterns onto the object with light intensity levels that vary sinusoidally;
capturing a portion of the projected patterns reflected from the object; and
processing the captured patterns using an intensity ratio function to obviate arctangent processing.

34. The computer-based system as set forth in claim 33, wherein the light intensity levels that vary sinusoidally in the step of projecting are processed in the step of processing as a defocused trapezoid.

35. The computer-based system as set forth in claim 34, wherein the step of processing includes generating an intensity ratio error compensation map that may be stored in a look-up table (LUT).

36. A computer-based system for carrying out object ranging/measurement by executing a set of computer-related instructions that implement a sinusoidal-based phase-shifting method using sinusoidal intensity-varying patterns, the method comprising steps of:
generating a first fringe pattern and generating at least three phase-shifted fringe patterns from the first fringe pattern, the at least three phase-shifted fringe patterns separated in phase by an equal amount with respect to each other;
projecting the phase-shifted fringe patterns onto the object with light intensity levels that vary sinusoidally;
capturing a portion of the projected patterns reflected from the object; and
processing the captured patterns using a fast arctangent function.

37. The computer-based system as set forth in claim 36, wherein the step of processing includes approximating arctangent calculation with a ratio function.

38. The computer-based system as set forth in claim 37, where the ratio function is defined by:
r=x/y, when |x|<|y|, and r=y/x, otherwise.

39. The computer-based system as set forth in claim 38, where the ratio function is implemented using a look-up table (LUT) for developing a phase function over a 2π range defined as:
φ=(π/2)(round((N−1)/2)+(−1)^{N}(˜φ+δ).

40. The computer-based system as set forth in claim 39, where the method steps carry out 3D shape measurement, including pattern capture, object image reconstruction and display at a speed of 40 frames per second at a frame resolution of at least 532×500 pixels.

41. The structured light system as set forth in claim 26, wherein the system processes the pre-processing calibration function to calculate a one-to-one correspondence between the camera and projector.

42. The structured light system as set forth in claim 41, wherein the system calculation of the one-to-one correspondence between the camera and projector includes transforming the camera image to the projector image.

43. A computer-based system for calibrating a projector to a camera for high-resolution light measurement by executing a set of computer-related instructions that implement a method comprising steps of:
obtaining a set of intrinsic parameters of the camera;
obtaining a set of intrinsic parameters of the projector;
using phase information, determine a correspondence between a camera image field, and a projection field by triangulation processing the set s of intrinsic and extrinsic parameters.

44. The computer-based system for calibrating as set forth in claim 43, wherein the step of obtaining the camera intrinsic parameters includes using a colored checkerboard instead of a black/white checkerboard to improve contrast that would be limited by use of a black/white checkerboard.

45. The computer-based system as set forth in claim 44, wherein the step of capturing captures a checkerboard image from the colored checkerboard and the step of processing maps the checkerboard image into the projector as a simulated captured checkerboard projector image.

46. The computer-based system as set forth in claim 45, wherein the simulated captured checkerboard projector image is used to determine a one-to-one pixel-wise mapping between the camera and projector coordinate images.

47. The computer-based system as set forth in claim 46, where the colored checkerboard is R, G or B, and the light projected thereon is G or B, R or B, or R and G, respectively.

48. The computer-based system as set forth in claim 47, wherein the intrinsic parameters of the projector provide for carrying out projector calibration in accordance with a camera calibration process.

49. The computer-based system as set forth in claim 48, further including calibrating extrinsic system parameters based on the intrinsic parameters calculated for the camera and projector.

50. The computer-based system as set forth in claim 49, wherein real measured object coordinates are calculated in accordance with the calibrated intrinsic and extrinsic parameters

51. A method for object ranging/measurement implements a trapezoidal-based three-step phase-shifting function using sinusoidal intensity-varied fringe patterns and intensity ratio obviating arctangent function processing, the method comprising steps of:
first processing to generate three fringe patterns in respective red (R), (G) green and blue (B) colors, and shifting the R, G and B fringe patterns an equal phase amount;
digitally projecting the R, G and B phase-shifted fringe patterns sequentially onto the object using sinusoidal intensity variation;
capturing the R, G and B phase-shifted fringe patterns as they are reflected from the object; and
second processing the captured fringe patterns to generate object coordinates.

52. The method for object ranging/measurement as set forth in claim 51, wherein the R, G and B patterns are projected gray scale.

53. The method for object ranging/measurement as set forth in claim 52, wherein the step of second processing includes reconstructing images from the captured fringe patterns.

54. The method for object ranging/measurement as set forth in claim 53, wherein the sinusoidal intensity-varied phase-shifted patterns is processed as a virtually defocused trapezoidal pattern.

55. The method for object ranging/measurement as set forth in claim 54, wherein defocus error introduced by the capturing is obviated.

56. The method for object ranging/measurement as set forth in claim 55, wherein error compensation includes generating and using an intensity-ratio look-up table (LUT).

57. The method for object ranging/measurement as set forth in claim 56, wherein the step of second processing includes calculating three intensity values as:
I₁(x,y)=I′(x,y)+I″(x,y)cos[φ(x,y)−α],
I₂(x,y)=I′(x,y)+I′(x,y)cos[φ(x,y)], and
I₃(x,y)=I′(x,y)+I″(x,y)cos[φ(x,y)+α].

58. The method for ranging/measurement as set forth in claim 57, wherein the step of second processing includes calculating intensity ratio as:
r(x,y)=(I₂(x,y)−I₁(x,y))/(I₃(x,y)−I₁(x,y))

59. The method for object ranging/measurement as set forth in claim 58, further comprising a step of pre-processing calibration in order to calibrate the projector by treating the projector as a virtual camera

60. A program storage device readable by machine, tangibly embodying a program of instructions executable by the machine to perform method steps for real-time three-dimensional (3D) object ranging/measurement as set forth in claim 51.
